(19) United States
(12) Patent Application Publication
(10) Pub. No.: US 2020/0258089 A1
(43) Pub. Date: Aug. 13, 2020

(54) TRANSACTION VERIFICATION IN POST-PAY PARKING FACILITY

(71) Applicant: FlashParking, Inc., Austin, TX (US)

(72) Inventors: Juan Fabian Rodriguez, Austin, TX (US); Dean Alan Cleaver, Austin, TX (US); Eliseo Joaquin Diaz, Austin, TX (US); Carlos Hernandez, Austin, TX (US)

(73) Assignee: FlashParking, Inc., Austin, TX (US)

(21) Appl. No.: 16/788,144

(22) Filed: Feb. 11, 2020

Related U.S. Application Data
(60) Provisional application No. 62/804,011, filed on Feb. 11, 2019.

(51) Int. Cl. G06Q 20/42; G07F 17/24; G06K 9/00; G08G 1/14

(52) U.S. Cl. CPC G06Q 20/42; G07F 17/24; G06Q 2240/00; G08G 1/148; G06K 9/00845

(57) ABSTRACT

A parking management method and system wherein the parking rate for a parking facility varies based on the capacity of the parking facility, weather or other factors. The current parking rate is visible on a display positioned at the entry to the parking facility or, alternatively, on a payment kiosk near or in the parking facility. As the driver accepts the displayed rate, a camera records both the rate and the driver, thereby providing verification that the driver accepted the displayed rate. When the driver leaves the parking facility, or in the event of a dispute over the rate agreed-upon by the driver, the photograph may be displayed as verification of the rate the driver accepted.

### PRIORITY STATEMENT UNDER 35 U.S.C. § 119 & 37 C.F.R. § 1.78

This non-provisional application claims priority based upon prior U.S. Provisional Patent Application Ser. No. 62/804,011 filed Feb. 11, 2019 in the names of Juan Fabian Rodriguez, Dean Alan Cleaver, Eliseo Joaquin Diaz, and Carlos Hernandez entitled “TRANSACTION VERIFICATION IN A POST-PAY PARKING FACILITY,” the disclosures of which are incorporated herein in their entirety by reference as if fully set forth herein.

### BACKGROUND OF THE INVENTION

Today, parking facility operators have two main alternatives for controlling revenue in parking facilities: gated parking access revenue control systems and pay-by-space revenue control systems.

A gated parking access revenue control system requires every entry and exit lane to the parking facility to have a parking gate operator. Those gates are connected to a ticket dispenser and/or device to verify parking. This system does not require enforcement because the parking gate operators will ensure drivers stop and take a ticket. However, this process significantly impedes entry and exit of the parking facility.

The pay-by-space revenue control systems include (i) a pay and display, (ii) pay-by-space, or (iii) pay-by-plate multi-space meter. This type of system facilitates entry and exit from the parking facility because it does not require the parking facility to have a parking gate operator.

In either the gated parking access revenue control systems or pay-by-space revenue control systems, the operators may allow drivers to access the parking facility and pay after they have finished parking, either at a kiosk or upon exit from the facility. This adds an added complication for parking operators who manage facilities with fluctuating parking rates because there is not a bona fide system to document a parking customer's acceptance of a rate when that parking customer first enters the parking facility. As more and more parking facilities move into on-demand-based pricing or engage in yield management systems, a parking facility's rates may fluctuate many times throughout the day. Without documentation of the rate which the customer agreed to pay when entering the facility, parking operators cannot demonstrate with certainty what parking rate a parking customer should pay when exiting. This creates a substantial issue when a parking customer disputes a parking rate.

There is a need, therefore, for a system and a method to capture the rate displayed to a parking customers at the time of entry into a parking facility so that rate can be properly verified to the parking customer at the time they exit the parking facility. Such a system would reduce the potential loss of revenue for parking operators in cases where drivers dispute the agreed-upon rate.

### SUMMARY OF THE INVENTION

Embodiments of the present invention relate generally to the methods and systems for parking facility management. More specifically those embodiments relate to offering a method to verify the terms of a parking customer transaction.

In one embodiment, as a vehicle enters a parking facility in which the parking rate varies based on the capacity of the parking facility, weather or other factors, the current parking rate is presented on a display visible to the driver, such as an interactive digital display. The driver agrees to the rate and then drives the vehicle into the parking facility to an open parking space. At the time the driver agrees to the rate, a camera records the identity of the driver and the rate displayed on the display. When the driver leaves the facility, the photograph may be displayed to the driver to assist in verifying that the driver agreed to the rate being charged. Alternatively, the photograph may be used by the parking facility operator as verification of the agreed-upon rate in the event of a payment dispute.

In another embodiment, a parking facility may have no gate entry and the driver, a passenger or another party could approach a pay-by-license-plate kiosk to make payment. In this embodiment, the current rate would be visible on the kiosk's display and a camera positioned in or near the kiosk would record the rate that is visible on the display at the time the party accepts the rate. The photograph could, once again be used for verification as the driver leaves the parking facility or in the event of a payment dispute.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 is a schematic depiction of one embodiment of the parking management system of the present invention in which a vehicle enters a parking facility;

FIG. 2 shows a dynamic display showing the current parking rate at a parking facility with an acceptance button;

FIG. 3 is a schematic depiction of one embodiment of the parking management system of the present invention in which a vehicle enters a parking facility; and

FIG. 4 shows a dynamic display with the parking rate and the photographic verification that the parking customer accepted the parking rate.

### DESCRIPTION OF THE PREFERRED EMBODIMENTS

The present invention is directed to improved methods and systems for, among other things, verification of rate acceptance for parking facilities. The configuration and use of the presently preferred embodiments are discussed in detail below. It should be appreciated, however, that the present invention provides many applicable inventive concepts that can be embodied in a wide variety of contexts other than one specifically described herein. Accordingly, the specific embodiments discussed are merely illustrative of specific ways to make and use the invention, and do not limit the scope of the invention. In addition, the following terms shall have the associated meaning when used herein:

“application” is a software program designed to run on a mobile device;

“cloud” means a collection of logical devices which may or may not include underlying physical servers, wherein all such logical devices may be accessed without any knowledge, or with limited knowledge, of the underlying physical devices, and wherein the collection of logical devices has persistent logical resources, but is non-deterministic in its use of physical resources;

“mobile device” means any portable computing device, typically having a display screen with touch input and/or a miniature keyboard, and includes, without limitation, the head unit; and

“parking facility” means an indoor or outdoor area for parking vehicles, including, for example, a parking garage, parking lot, parking ramp, car park and the like.

A parking system is presented in which the rates for parking vary based on variables determined by the parking facility operator. In one embodiment, the variable may be facility occupancy, in which case the system may be configured to increase prices when the facility reaches a certain capacity. In this instance, an event at a venue proximal to the parking facility operator's facility may cause high demand for parking in the surrounding area. The operator may pre-set the system of the present invention to increase the parking rate, either by a binary amount or incrementally, as the capacity of the facility increases.

In addition, the system may be configured to increase the parking fee based on a set dollar amount. For example, if the facility is at 20% occupancy, the parking rate may be $5 per hour, but at 30% occupancy, the rate increases to $6 per hour. Alternatively, the system may be configured to increase the parking fee on a percentage basis. For example, if the facility is at 20% occupancy, the parking rate may be $5 per hour but, and, as the occupancy rate exceeds 70%, the parking rate may increase by 30% and as the occupancy exceeds 90%, the rate increases by 100%.

In other embodiments of the present invention, the parking facility operator may elect to modify the parking rate based on vehicle size, model, weight, capacity, or other similar factors. Larger vehicles, such as oversized SUVs, may hold a high number of passengers. The system is equipped with one or more detectors configured to determine whether the vehicle entering the parking facility is compact or oversized, the occupancy capacity of the vehicle, and other measurable criteria relevant to the parking facility operator. Detectors may include, for example, license plate recognition cameras and vehicle type detection cameras and sensors.

In yet other embodiments of the present invention, the parking facility operator may elect to modify the parking rate based on ambient weather. Those skilled in the art can appreciate that inclement weather may cause covered parking spots to be in higher demand. The system is equipped with weather sensors or other data sources providing information to the system regarding the current and forecasted weather conditions. Parking prices may be adjusted, again either by a binary amount or incrementally, based on the weather conditions at the time the vehicle enters the parking facility.

In addition to the factors described above for adjusting parking fees, there are additional reasons the price of a parking price may be adjusted. For example, a parking facility operator may choose to adjust parking rates based on certain behavioral information, such as the frequency a driver uses the facility, the zip code in which the vehicle is registered, the type of vehicle, or the type of credit card being used to pay for the parking space.

As will be appreciated, parking rates may fluctuate based on one or more of the above criteria on a minute-by-minute or hour-by-hour basis throughout each day. In many instances the rates visible on a display in the entry lane to a parking facility may also be visible to a driver exiting the facility. This may cause the exiting driver to become confused as to the rate he agreed to pay when entering, or may result in a dispute over the actual fee to be paid.

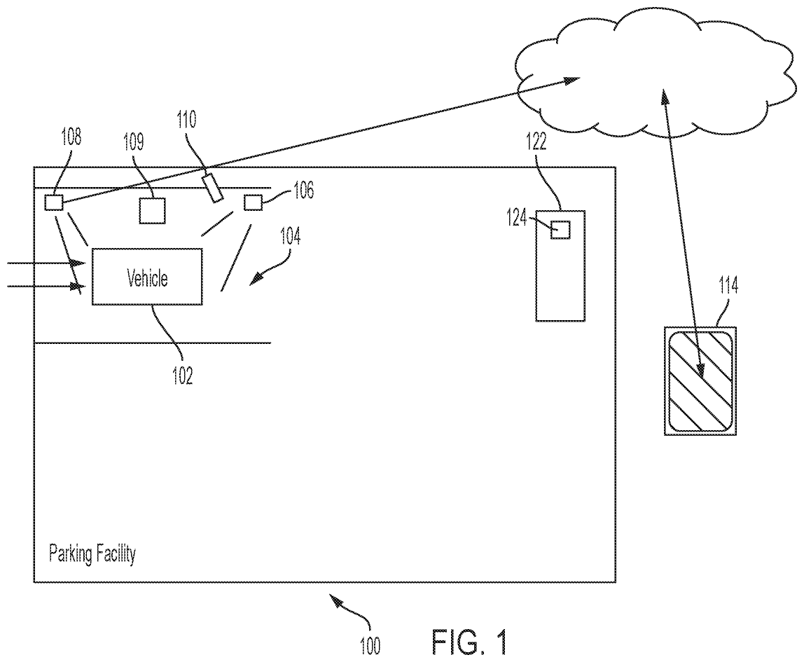

Referring now to FIG. 1 which depicts a parking facility 100 configured with one embodiment of the present invention. A vehicle 102 enters a parking facility's entry lane 104. A display on a kiosk 109 shows the driver the current rate for parking in the parking facility 100. In some embodiments a license plate reader 108 also reads and records the vehicle's license plate. The driver agrees to the rate as discussed in more detail below and then drives the vehicle into the parking facility 100 to an open parking space. At the time the driver agrees to the rate, a camera positioned in the kiosk 109 records the identity of the driver and the rate displayed on the display of the kiosk 109.

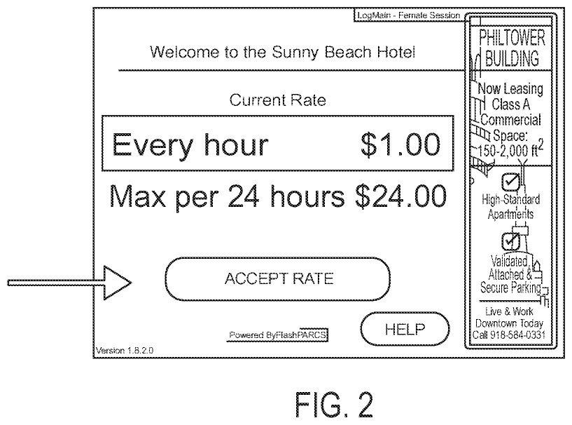

Alternatively, a parking facility 100 may have no gate entry and the driver, a passenger or another party could approach a pay-by-license-plate kiosk 122 to make payment. In this embodiment, the rate would be visible on the kiosk's display 124, such as the current rate information shown in FIG. 2, and a camera positioned in or near the kiosk 122 would record the party's identity and the rate visible on the display 124 at the time the party accepted the rate.

FIG. 2 shows a digital display located at a parking facility utilizing an embodiment of the present invention. In this instance, the display shows the current price the driver acknowledges and accepts by touching the “Accept Rate” button before entering the parking facility. As discussed above, the information on the display may change based on the parking facility's capacity, time of day, or other factors and the current rate is updated automatically as the rate changes. However, because the prices may fluctuate throughout a day, the driver may, for example, see a lower rate on the display when leaving the facility and believe that the rate he is paying is too high.

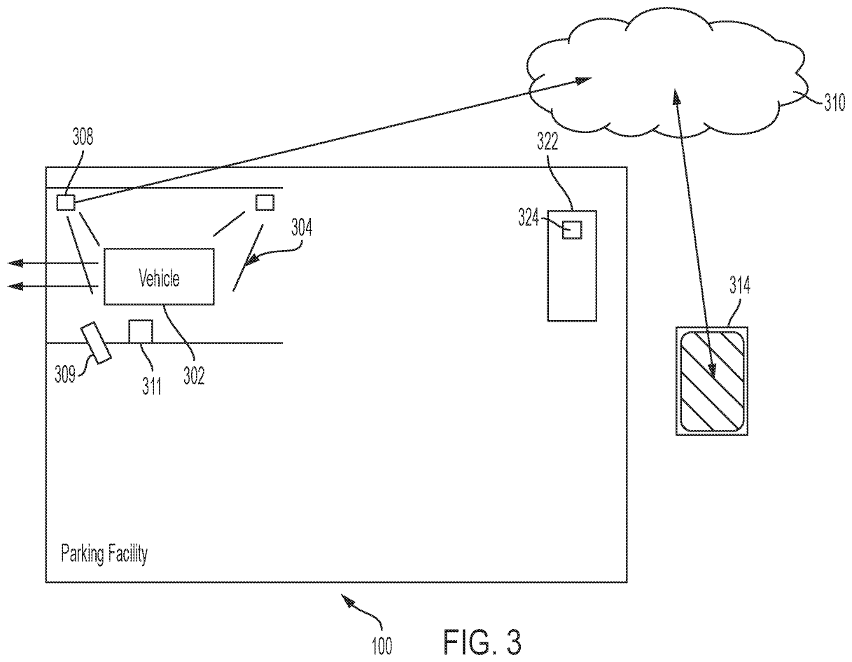

As the driver leaves the parking facility 100, depicted schematically in FIG. 3, the display in the kiosk 311 shows the driver the agreed-upon rate for parking in the parking facility 100. Alternatively or in addition, a display 309 shows the driver the agreed-upon rate for parking in the parking facility 100. In each case, the rate is the same rate that the driver agreed to when entering the facility. The agreed-upon rate may be accompanied by the photograph taken at the time the driver entered the parking facility 100. In some embodiments, the agreed-upon rate and/or the photograph may be transmitted through the cloud 310 to the mobile device 314 of the driver.

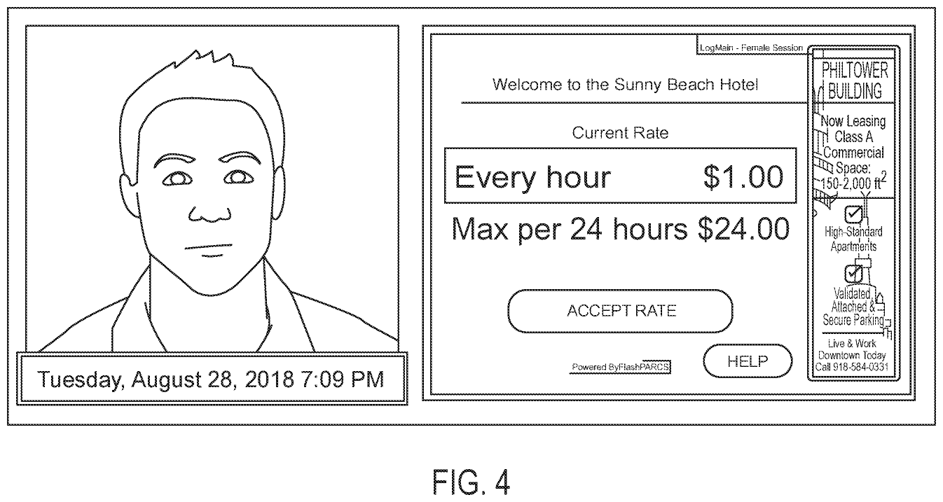

In the embodiment in which the driver paid at a kiosk 322, the display 324 on the kiosk 322 presented at the time of payment may appear as shown in FIG. 4, with the image of the party that accepted the current parking rate on the left and the kiosk screen showing the parking rate on the right.

In some embodiments, as the system continues to gather data, it will analyze that data to understand trends and other factors relevant to past events. The analysis of that information will allow the system to understand patterns within a given set of events (occupancy, weather, local events, etc.) based on the transactional information received by the facility. This artificial intelligence functionality will continue to provide additional value as the amount of information gathered by the system grows.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for rate acceptance and image capture for parking facilities known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A system for verification of agreed-upon parking rates, comprising:
a parking facility having plurality of parking spaces;
a display positioned at an entry to the parking facility, the display configured to convey parking rate information to a driver of a vehicle entering the parking facility;
a computer processor configured to modify the parking rate of a parking space based on predefined criteria and present the current parking rate on the display;
a camera positioned proximal to the display and the entry; wherein, when the driver accepts the parking rate, the camera photographs the driver and the display,
thereby verifying the parking rate accepted by the driver.

2. The system for verification of agreed-upon parking rates of claim 1, wherein the predefined criteria is weather conditions when the vehicle enters the parking facility.

3. The system for verification of agreed-upon parking rates of claim 1, wherein the predefined criteria is a formula in which prices fluctuate based on occupancy of the parking facility.

4. The system for verification of agreed-upon parking rates of claim 1, wherein the predefined criteria is the presence of events at nearby facilities.

5. The system for verification of agreed-upon parking rates of claim 1, wherein the parking facility is a parking garage.

6. The system for verification of agreed-upon parking rates of claim 1, wherein the camera is a movie camera that continuously records activity at the entry to the parking facility.

7. The system for verification of agreed-upon parking rates of claim 1, wherein the camera takes a still photo of the driver and the display when the driver accepts the current parking rate.

8. The system for verification of agreed-upon parking rates of claim 1, wherein the display is interactive and after the current price is displayed to the driver, the driver accepts the price by touching the display.
